(19) United States
(12) Patent Application Publication
(10) Pub. No.: US 2015/0244218 A1
(43) Pub. Date: Aug. 27, 2015

(54) ROTOR FOR A PERMANENT MAGNET ELECTRIC MACHINE AND USE THEREOF

(71) Applicants: CONTINENTAL TEVES AG & CO. OHG, Frankfurt (DE); CONTINENTAL AUTOMOTIVE GMBH, Hannover (DE)

(72) Inventors: Tom Kaufmann, Ippenschied (DE); Thomas Knopik, Mainz (DE); Bernd Piller, Dreieich (DE); Peter Stauder, Mainz (DE)

(73) Assignee: Continental Automotive GmbH a corporation

(21) Appl. No.: 14/428,025

(22) PCT Filed: Sep. 5, 2013
(86) PCT No.: PCT/EP2013/068324

§ 371 Date: Mar. 13, 2015

(30) Foreign Application Priority Data
Sep. 14, 2012 (DE) 10 2012 216 431.6
May 29, 2013 (DE) 10 2013 009 115.2

(51) Int. Cl. H02K 1/27; H02K 1/28

(52) U.S. Cl. CPC H02K 1/2773; H02K 1/28

(57) ABSTRACT

A rotor (2) for a permanent magent brushless DC machine, which rotor is arranged concentrically about a rotor axis (1′) and has a passage opening (8) running along the rotor axis (1′) for accommodating a shaft (22). Permanent magnets (3) and the pole segments (4) extend along the rotor axis (1′), with the permanent magnets (3) and the pole segments (4) arranged alternately around the rotor axix (1′) in the circumferential direction. The rotor further has a cross-sectional area (14) of at least one pole segment (4) in at least a first pole segment region (5), is asymmetrical with at least one shaped portion (6) arranged in a radially outer region, with respect to therotor axis (1′), of the pole segment (4). The shaped portion (6) extends substantially in a circumferential direction (1″). Furthermore, the invention describes the use of the rotor according to the invention.

### CROSS REFERENCE TO RELATED APPLICATIONS

This application claims priority to German Patent Application Nos. 10 2012 216 431.6, filed on Sep. 14, 2012; 10 2013 009 115.2, filed on May 29, 2013; and PCT/EP2013/068324, filed Sep. 5, 2013.

### FIELD OF THE INVENTION

The present invention relates to a rotor for a permanent magnet electric machine and the use thereof.

### BACKGROUND

Electric machines are electric motors or electric generators, for example, wherein said electric motors or electric generators perform a wide variety of tasks in particular in motor vehicles.

DE 10 2010 061 778 A1 describes a spider-type rotor of an electric machine, in which the permanent magnets are arranged in the form of a spider in a rotor basic body, wherein the rotor axis represents the fictitious point of intersection and the permanent magnets are oppositely polarized alternately in the circumferential direction. The magnetic flux is guided via pole segments arranged between the permanent magnets to the air gap in order to achieve a concentration of the magnetic flux. The magnetic south pole and the magnetic north pole therefore alternate in the circumferential direction of the rotor.

In order to reduce leakage fluxes and increase the efficiency of the machine, DE 10 2010 061 778 A1 describes a connecting sleeve connecting the rotor shaft and a rotor basic body, which connecting sleeve consists of a diamagnetic or paramagnetic material.

Since the magnetic remanance of ferretic permanent magnets is comparatively low at 0.4 to 0.45 tesla, for example, materials which comprise, inter alia, rare earth metals are often used for applications in permanent magnet electric machines. With the neodymium-iron-boron (NdFeB) magnets which are often used, with a proportion of neodymium of approximately 30% and a proportion of dysprosium of approximately 1.7 to 7%, a remanance of approximately 1.2 to 1.3 tesla is achieved at present. A further group of materials for permanent magnets comprises the Samarium-cobalt magnets, with which a remanance of approximately 1 tesla is achieved at present.

The physical size of a permanent magnet electric machine is dependent on the magnetic flux density which can be achieved in the gap between the rotor and the stator. Owing to the relatively low remanance, a machine designed on the basis of ferrite magnets would need to have approximately three times the total length as a machine including NdFeB magnets for a comparable performance. Using permanent magnets with a high remanance, therefore, machines can be developed which can be dimensioned in a more space-saving manner given the same performance or with an increased performance given the same space requirement than machines with permanent magnets having a lower remanance, such as consisting of ferrite, for example.

In addition to a low weight or low physical volume, it is also desired to avoid undesired magnetic short circuits, so-called leakage fluxes of the magnetic flux, since these reduce the efficiency of a machine. Leakage fluxes between the pole pieces, for example in the region of the air gap or towards the shaft, can be reduced by avoiding magnetically conductive materials between the pole pieces, as is described in DE 10 2010 061 778 A1.

The magnetic field is influenced by the geometry of the pole segments, wherein, in a manner known per se, circle radii with radii which become smaller towards the edge of the pole segments, are provided. In these embodiments, meaningful field shaping is not possible in the region between the pole segments, in a radially outer region (with respect to the rotor axis) of the permanent magnets, since no material is provided in this region which can have an influencing effect. Owing to the extension of the pole pieces in the radially outer region (with respect to the rotor axis) of the pole segments and permanent magnets, at the limit up to the formation of a continuous bridge, the leakage flux increases and the efficiency of the machine is reduced. In addition, torque ripple results from the harmonic content of the magnetic flux, in the gap between the rotor and the stator. In this case, the fifth and seventh harmonics result in sixth-order torque ripple. This results owing to frequency mixing, described by the multiplication of the fifth harmonic and the fundamental of the current (5+1=6; 7−1=6). The further harmonics occurring are integrally divisible by 6 (6, 12, 18, 24, . . . ), wherein the corresponding ones always result from the respective integers +/−1 (5 and 7, 11 and 13, . . . ). Depending on the embodiment of the motor topology (for example 8 poles on the rotor and 12 pole shoes on the stator), these harmonics are suppressed to a differing extent.

High raw material prices in particular for rare earth metals and uncertain access to the distribution and markets thereof are factors facing the high cost pressure in the automotive industry. Furthermore, existing electromachines do not sufficiently meet requirements for modern applications in motor vehicles, in particular in respect of efficiency, low cogging torque and torque uniformity.

The object of the present invention consists in providing a permanent magnet electric machine, in particular for use in motor vehicles, whose efficiency and/or cogging torque is reduced and/or whose torque uniformity is further improved.

This object is achieved by a rotor for a permanent magnet electric machine as described herein.

### SUMMARY AND INTRODUCTORY DESCRIPTION OF THE INVENTION

The rotor according to the invention for a permanent magnet electric machine, in particular a brushless DC machine, which rotor is arranged concentrically around a rotor axis and has a through-opening extending along the rotor axis for receiving a shaft, including permanent magnets and pole segments extending along the rotor axis, wherein the permanent magnets and the pole segments are arranged alternately in the circumferential direction around the rotor axis and a cross-sectional area of at least one, in particular each, pole segment is formed in at least one first pole segment region so as to be asymmetrical with at least one shaped portion arranged in a radially outer (with respect to the rotor axis) region of the pole segment, wherein the shaped portion extends substantially in a circumferential direction.

In accordance with a preferred embodiment of the invention, at least one, in particular each, pole segment includes at least one second pole segment region, in which at least one shaped portion, which forms asymmetrically a cross-sectional area, is provided in a radially outer (with respect to the rotor axis) region in a substantially opposite circumferential direction with respect to the shaped portion in the first pole segment region.

Preferably, at least one, in particular each, pole segment includes at least one third pole segment region, wherein the third pole segment region is substantially symmetrical and without a shaped portion.

Further preferably, for an, in particular each, pole segment, the proportion of the first pole segment region(s) is approximately 25%, the proportion of the second pole segment region(s) is approximately 25%, and the proportion of the third pole segment region(s) is approximately 50% of all the pole segments making up the rotor.

Preferably, at least one, in particular each, pole segment consists of a substantially magnetically conductive, in particular ferromagnetic and/or ferrimagnetic material. Preferably, ferrites are used as the materials for the permanent magnets.

Preferably, a maximum spacing between the shaped portion and the rotor axis is less than or equal to an outer radius of the rotor.

In a preferred embodiment, at least one torque transfer disk is provided on at least one end face of the rotor, which at least one torque transfer disk has an opening extending in the direction of the rotor axis for receiving and mechanically connecting a shaft, wherein the opening in the torque transfer disk in particular has a smaller diameter than the through-opening.

Preferably, at least one means for fixing the torque transfer disc is provided on the pole segment(s), wherein in particular at least one opening and/or cutout is provided in at least one pole segment, into which at least one rod-shaped element is inserted, which rod-shaped element is mechanically connected to the torque transfer disc.

In accordance with a further embodiment, at least one shaped portion is formed in the region of a, in particular each, pole segment on the torque transfer disc in a radially outer region (with respect to the rotor axis) of the torque transfer disc, wherein the shaped portion extends substantially in a circumferential direction.

Particularly preferably, the torque transfer disc consists of a substantially magnetically nonconductive and/or slightly conductive, in particular a diamagnetic and/or paramagnetic material.

Preferably, the shaft has at least one form element for receiving recesses surrounded by the pole segments and/or pole segment regions and/or at least one knurl is provided on the circumference of the shaft.

In accordance with a preferred development of the invention, magnetically conductive connecting webs are provided, which connect only pole segments and/or magnetically identically polarized pole segment regions of different pole segments.

The invention also relates to an electric machine including a rotor in accordance with the above-described preferred embodiments and the use of the rotor and/or the permanent magnet machine in a motor vehicle, in particular in a motor vehicle braking system and/or motor vehicle steering system.

Despite a comparatively low remanance of ferrite magnets or comparatively available permanent magnets, without rare earth metals, by means of the invention it is possible to design an electric machine which, in comparison with permanent magnet machines with rare earth metals, has only a slightly increased space requirement and is more space-saving than alternative motor concepts such as asynchronous and reluctance machines. By avoiding the rare earth metals which are cost-intensive and sometimes difficult to obtain and owing to the simple basic construction, in addition costs are saved and access to materials is simplified. In the case of such materials and in the case of the use of permanent magnets which contain rare earth metals, improved efficiency, increased torque uniformity and lower cogging torque are achieved.

### BRIEF DESCRIPTION OF THE INVENTION

Further preferred embodiments result from the description below relating to exemplary embodiments with reference to the figures, in which:

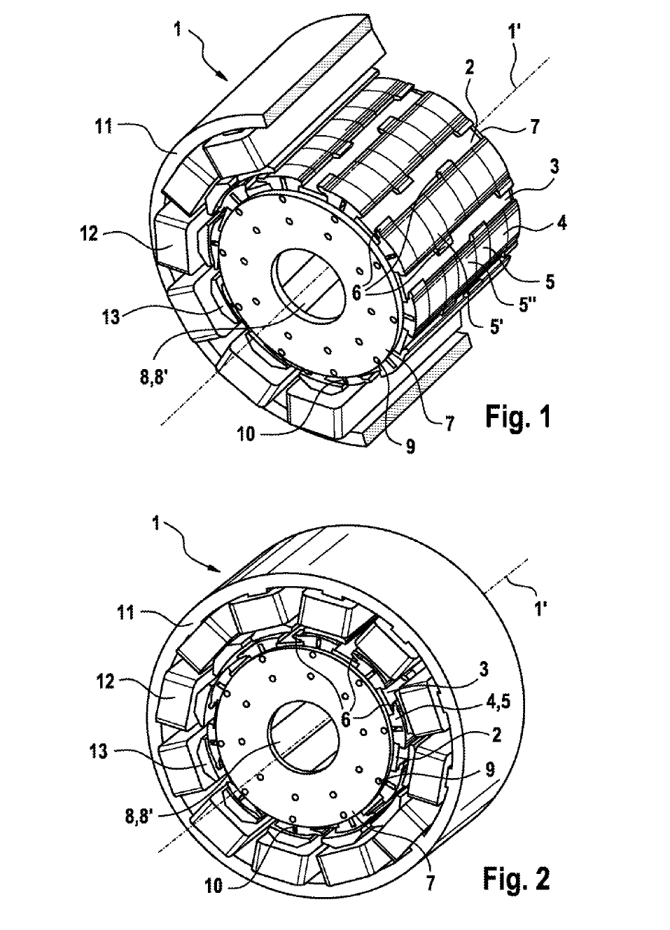

FIG. 1 shows a simplified sectional illustration of the permanent magnet machine according to the invention,

FIG. 2 shows a simplified illustration of the permanent magnet machine,

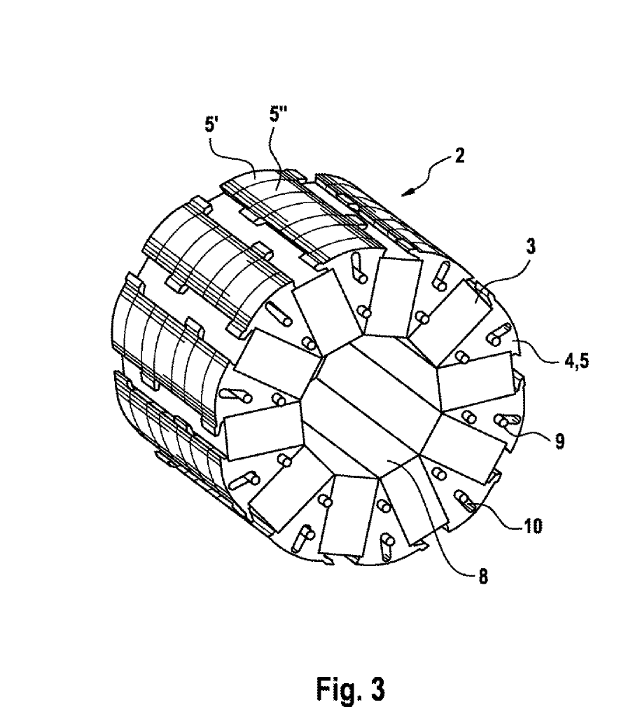

FIG. 3 shows a simplified illustration of the rotor according to the invention,

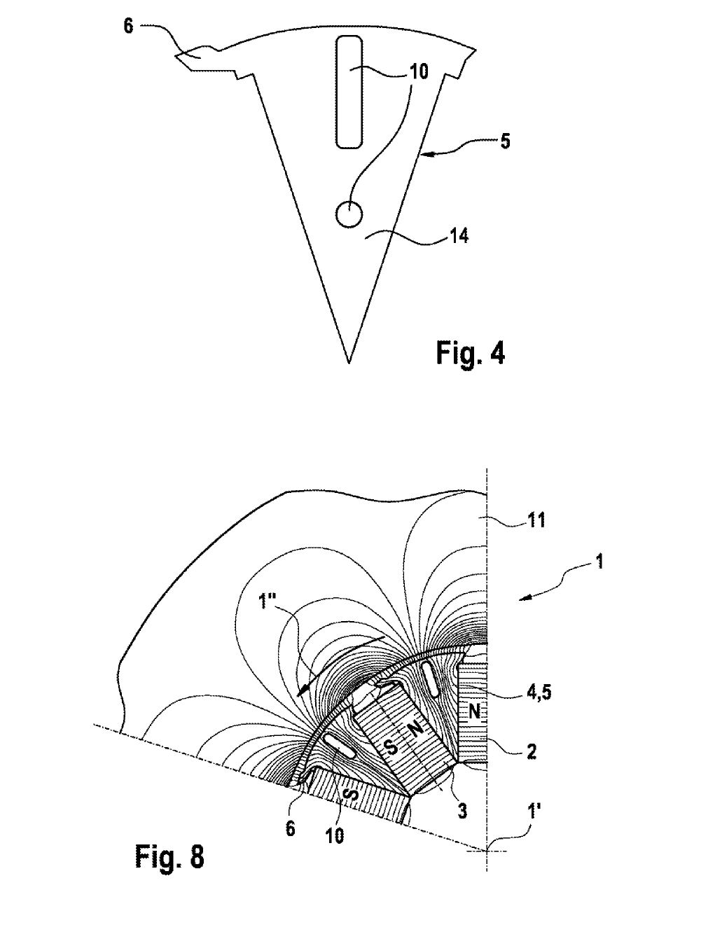

FIG. 4 shows a separated pole segment region of the rotor,

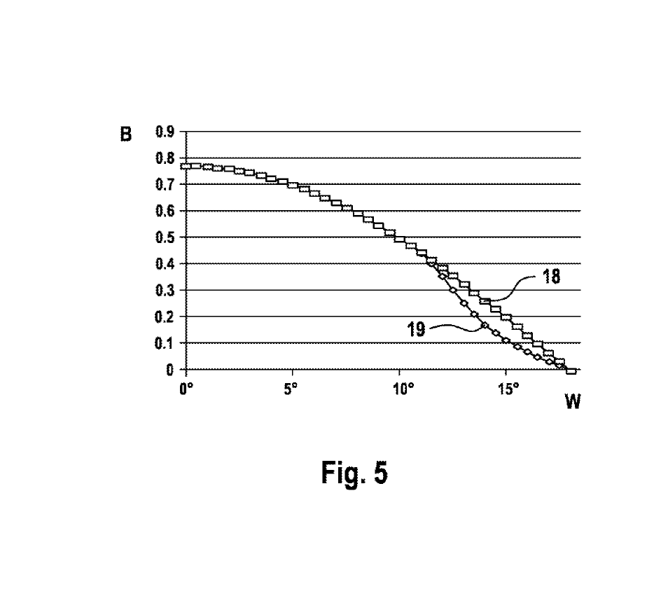

FIG. 5 shows a profile known per se of the flux density as a function of the rotor angle in accordance with the prior art,

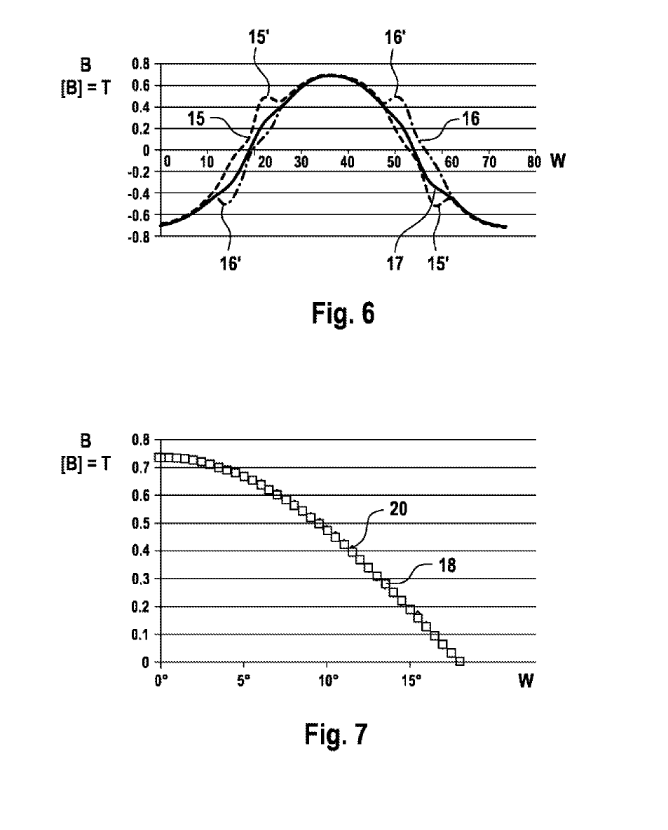

FIG. 6 shows an exemplary profile of the flux density as a function of the rotor angle of the electric machine according to the invention,

FIG. 7 shows a further exemplary profile of the flux density as a function of the rotor angle in accordance with a further embodiment of the electric machine,

FIG. 8 shows a simulated profile of magnetic lines of force of the machine,

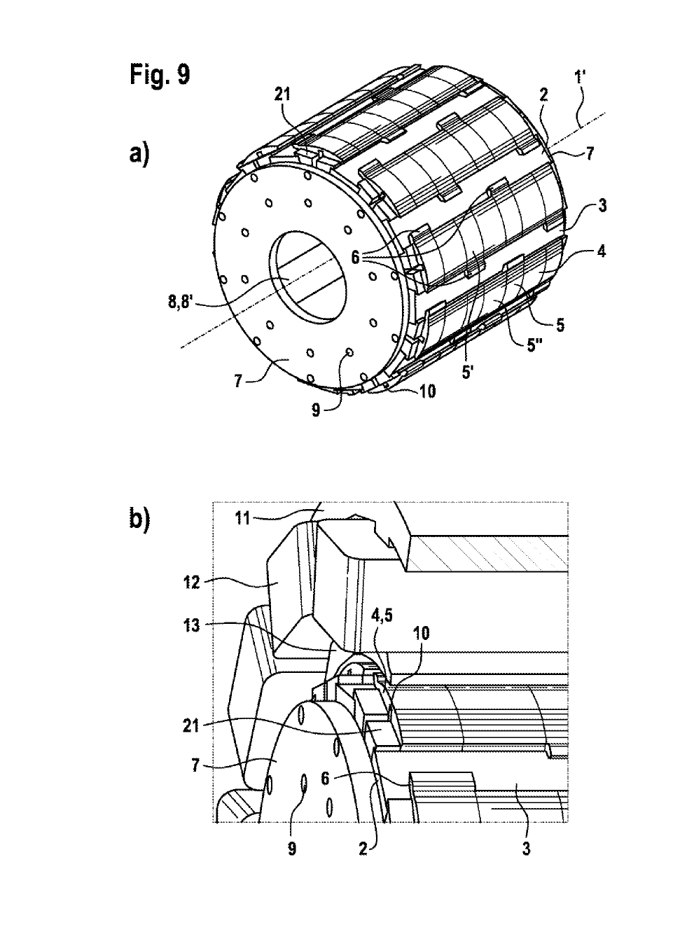

FIG. 9 shows illustrations of a further exemplary embodiment of the electric motor according to the invention,

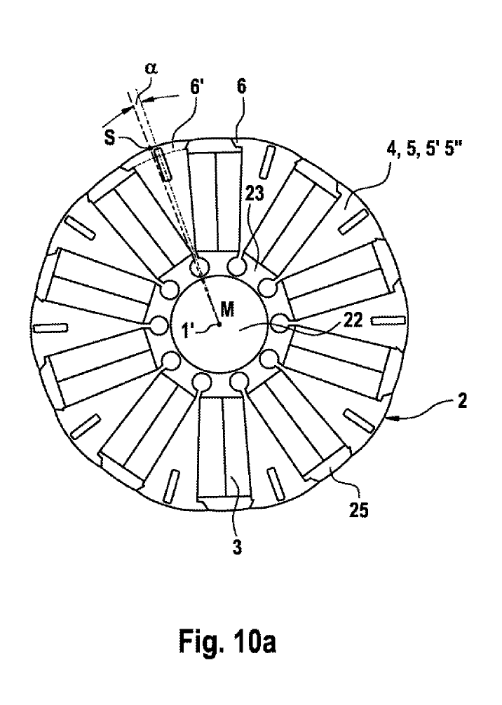

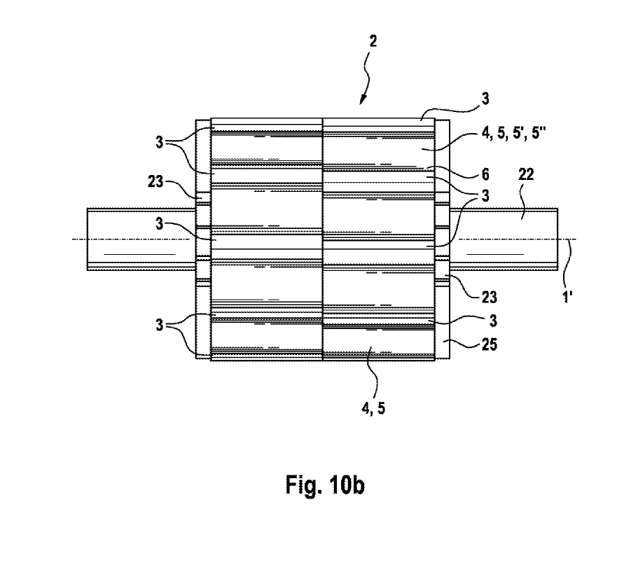

FIG. 10 shows an exemplary embodiment of the rotor according to the invention with design developments as regards the reduction of leakage fluxes, and

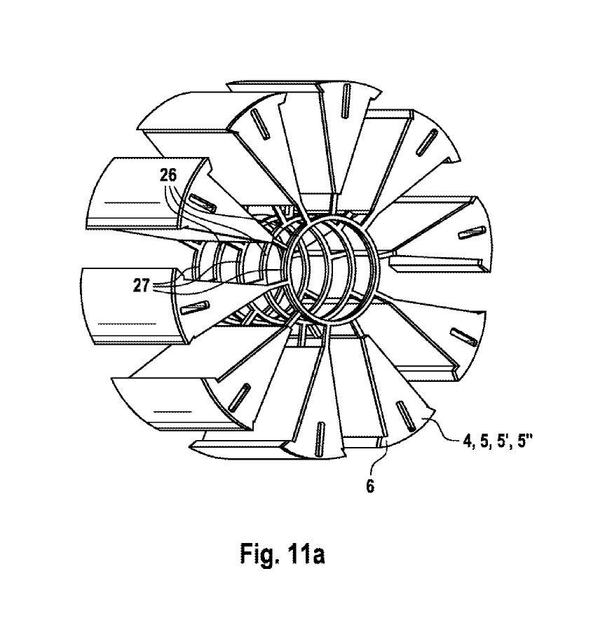

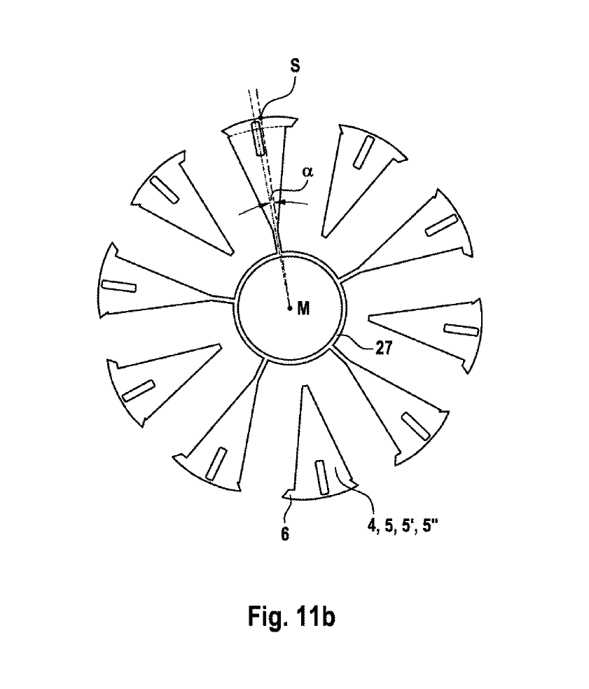

FIG. 11 shows a further exemplary embodiment of the rotor according to the invention with design developments in respect of the reduction of leakage fluxes.

### FURTHER DESCRIPTION OF THE INVENTION

In order to make it possible to describe the exemplary embodiments briefly and easily, identical elements have been provided with the same reference symbols and in each case only the details which are essential to the invention are explained.

FIG. 1 shows a perspective illustration of the electric machine 1 according to the invention restricted to the essential components, namely the stator 11 and the rotor 2, using the example of an electric motor 1, wherein the stator 11 is depicted as a section for illustrative purposes. FIG. 2 likewise shows a simplified, perspective illustration of the electric motor 1, but without a section.

The field coils 12 are arranged around the circumference of the rotor 2 on pole shoes 13 of the stator 11 and are actuated electrically in a manner known per se in order to bring about a rotary movement of the rotor by generation of a rotating magnetic field. The rotor 2 includes the permanent magnets 3 and the pole segments 4, which extend along the rotor axis, and, surrounding the rotor axis 1′ concentrically, are arranged around the rotor axis alternately in a circumferential direction. As already described in the prior art, the permanent magnets are oppositely polarized, alternating in the circumferential direction. In order to achieve a concentration of the magnetic flux, the magnetic flux is guided via the pole segments 4 to the air gap, wherein the permanent magnets 3 each adjoin a pole segment 4 with the same magnetic polarization. Therefore, the magnetic south pole and the magnetic north pole alternate in the circumferential direction of the rotor.

The rotor 2 is mechanically connected, rotatably about the rotor axis 1′, to a shaft (not illustrated) of the electric motor via the torque transfer discs 7 provided on both end faces of the rotor 2. In order to pass through and fasten the shaft, openings 8′ are provided in the torque transfer discs 7 in the direction of the rotor axis 1′. The rotor 2 furthermore has a through-opening 8 extending in the direction of the rotor axis 1′ in order to pass through the shaft.

In order to avoid leakage fluxes of the rotor in particular with respect to the shaft, the torque transfer discs 7 consist of a substantially magnetically nonconductive or slightly conductive material, such as copper or aluminum, for example. In particular when a shaft consisting of a material which is substantially magnetically conductive is used, the openings 8′ in the torque transfer discs 7 are embodied with a smaller diameter than the through-opening 8. As a result, leakage fluxes of the permanent magnets 3 and pole segments 4 with respect to the shaft are reduced depending on the spacings therebetween.

As an alternative or in addition to the torque transfer discs 7, at least one connecting sleeve consisting of a diamagnetic and/or paramagnetic material could be introduced between the shaft and the rotor 2, for example, which connecting sleeve firstly transfers torque to the shaft and/or to the rotor 2 or can support the transfer of torque to the shaft and/or to the rotor 2 and secondly suppresses leakage fluxes.

In accordance with this exemplary embodiment, in each case two rods having circular cross sections are introduced into openings 10 provided therefor in each pole segment 4 and the torque transfer discs 7 and are in particular mechanically connected to the torque transfer discs 7 in such a way that the torques arising during operation can be transferred. In order to illustrate this, FIG. 3 shows a rotor 2 without torque transfer discs 7.

In order to avoid eddy currents, the pole segments 4, in a manner known per se, consist of laminate stacks, but regions of the pole segments 4 consisting of solid material can also be provided. The pole segments 4 have pole segment regions 5, which have shaped portions 6 forming the cross-sectional area 14 asymmetrically in a radially outer (with respect to the rotor axis 1′) region. The cross-sectional area 14 is illustrated for clarification purposes in FIG. 4. In a first pole segment region 5, which is provided, by way of example, in each pole segment 4 twice along the rotor axis 1′, the shaped portions point substantially in a first circumferential direction 1″. In the case of a second pole segment region, which is likewise provided twice along the rotor axis 1′, the shaped portions point substantially in a second circumferential direction 1″ opposite the first circumferential direction. The maximum spacing between the shaped portions 6 and the rotor axis 1′ is less than or equal to the outer radius of the rotor 2. Each pole segment region can in this case be assembled from separate laminations or manufactured wholly or partially from solid material.

FIG. 4 shows the cross-sectional area 14 of a pole segment region 5 with a shaped portion 6, wherein it is possible to select in which of the circumferential directions the shaped portion 6 is intended to point. The pole segment regions 5, 5′, 5″ have, in the radially outer region (with respect to the rotor axis 1′), circular radii known per se with radii which become smaller towards the edge of the pole segment regions 5, 5′, 5″ with respect to the rotor axis 1′. Each pole segment 4 also has a third pole segment region 5″ which is provided three times along the rotor axis 1′ and is substantially symmetrical, without a shaped portion 6.

As already explained, owing to harmonics of the magnetic flux, torque nonuniformities arise in the gap between a rotor and a stator. A frequently used embodiment of an electric machine has 8 poles on the rotor side and 12 pole shoes on the stator side, but does not demonstrate any suppression of these harmonics, for which reason a sinusoidal air-gap field needs to be sought, which in turn is determined by the geometry of the pole segments.

An exemplary profile of the magnetic flux density B as a function of the rotor angle W of a 10-pole rotor corresponding to an embodiment known per se of an electric motor is illustrated in FIG. 5. In the region of the pole segment (the axis of symmetry is at 0°), the magnetic flux density 19 in accordance with the prior art is largely equal to a cosinusoidal reference curve 18 which is likewise illustrated. In the radially outer region between two pole segments, the magnetic flux density of the 10-pole electric motor deviates substantially from the cosinusoidal reference curve. If the pole segments were to be extended further in order to improve the torque uniformity, in the extreme case until a continuous bridge is formed, the leakage flux would increase substantially and the efficiency would reduce.

FIG. 6 illustrates an exemplary profile of the magnetic flux density B of a preferred embodiment of the electric machine 1 according to the invention as a function of the rotor angle W, in which the pole segments 4 are divided in approximately equal proportions into pole segment regions 5 and 5′ with shaped portions 6 in the first circumferential direction and the opposite circumferential direction 1″. For illustrative purposes, the regions with shaped portions 6 have been illustrated as being separated into the first circumferential direction 1″ (15) and the circumferential direction 1″ opposite this (16) in addition. Owing to the shaped portions 6, depending on the direction of the shaped portions 6 in each case one overshoot 15′, 16′ of the magnetic flux density results in this region. The resultant magnetic flux density 17 becomes symmetrical again owing to the superimposition of the two pole segment regions 5, 5′ and demonstrates overshoots in the angular regions, in which, as shown in FIG. 5, there was a reduced magnetic flux density 19 in comparison with the cosinusoidal reference curve 18.

The number and arrangement of the pole segment regions 5, 5′, 5″ in each pole segment 4 can be configured depending on the requirement for efficiency and torque uniformity, wherein differences between the individual pole segments can also be realized. In the exemplary embodiment shown in FIGS. 1, 2 and 3, a proportion of the first pole segment regions 5 of approximately 25%, a proportion of the second pole segment regions 5′ of approximately 25% and a proportion of the third pole segment regions 5″ of approximately 50% is provided over the entire length of a pole segment 4 along the rotor axis 1′. This results in the magnetic flux density 20 of the electric machine 1 according to the invention largely becoming aligned with the cosinusoidal reference curve 18 shown in FIG. 7. A simulated profile of magnetic lines of force of a detail with a first pole segment region 5 of the electric motor according to the invention is depicted in FIG. 8.

If the pole segment regions 5, 5′, 5″ of a pole segment 4 are further combined, for example in such a way that in each case a cohesive first pole segment region 5 with a shaped portion 6 in the circumferential direction 1′, then a third pole segment region 5″ without a shaped portion, and thereafter a second pole segment region 5′ with a shaped portion 6 in the opposite circumferential direction 1′, the shaped portions 6 of the pole segment regions 5, 5′ could optionally also be arranged on the torque transfer disc 7.

FIG. 9 shows different perspective illustrations in FIG. 9a) and FIG. 9b) of a further exemplary embodiment of the rotor 2 according to the invention. The rotor 2 is extended in comparison with the above-described exemplary embodiment, as a result of which, in addition to the flux concentration of the embodiment as spider-type rotor, an axial flux concentration is generated. Owing to the field coils 12 which are arranged on the stator 11 and which protrude axially beyond the pole shoes 13, the rotor 2 can be axially longer, relative to the stator 11, on both sides of the electric machine 1. Therefore, the electric machine 1 can be configured axially with a total length which is reduced by these lengths on both side. Owing to the reduced turns length, therefore, lower electrical losses are generated. In order to reduce the inertia and to avoid axial magnetic fluxes in the gap, the protruding pole segment regions 21 could be flat at the circumference, i.e. could be provided without circular radii with radii which become smaller towards the edge of the pole segments.

FIGS. 10 and 11 show different illustrations and perspective views of further preferred configurations of the rotor 2, wherein only the components which are most necessary for explaining the preferred developing features are depicted. In contrast to the previously described embodiments, the apex S of the pole segment cap 6′, indicated by means of a dashed line, of pole segment 4 or pole segment region 5, 5′, 5″ or the connecting line depicted for illustrative purposes between the center point M of the rotor 2 and the apex S is shifted through an angle α, for example 3°, with respect to the axis of symmetry of the further part of pole segment 4 or pole segment region 5, 5′, 5″, which is illustrated by a dashed-dotted line, as can be seen in particular in FIGS. 10a) and 11b). In order to explain the asymmetry of the pole segment regions 5, 5′, 5″, only pole segment regions with shaped portions 6 in a first circumferential direction 1″ have been depicted in FIG. 10a), but not pole segment regions 5, 5′, 5″ which are behind this in the viewing direction and have shaped portions 6 in the opposite circumferential direction. The further design developments of the exemplary embodiments of FIGS. 10 and 11 focus substantially on a reduction in or avoidance of leakage fluxes from a first pole segment 4 to a further pole segment 4 in the region of the through-opening 8. The described design details can in this case be used optionally or additionally to exemplary embodiments already described. As shown in FIG. 10a) (perspectives parallel to the axial direction) and FIG. 10b) (perspective perpendicular to the axial direction), the rotor 2 has a shaft 22, which includes form elements 23 for mechanically fixing recesses 24 of the pole segments 4, wherein the shaft 22 is in particular antimagnetic and is produced using an extrusion method. In the region of the bearing (not illustrated) of the electric motor 1, the shaft 22 preferably has a cylindrical shape along the rotor axis 1′. Final fixing of the components of the rotor 2 takes place by means of encapsulation by plastic injection molding 25, as a result of which the centrifugal forces during continuous operation can be absorbed more effectively. In order to improve the torque transfer to the shaft 22, the form elements 23 preferably protrude axially beyond the permanent magnets 3 or pole segments 4, wherein the protruding part of the form elements 23 is enclosed by an encapsulation by plastic injection molding 25 so as to form an effective form fit.

Corresponding to the embodiment in FIGS. 11a) and 11b), pole pieces 4 or pole segment regions 5, 5′, 5″ of the same magnetic potential are connected in the circumferential direction of the rotor 2 by means of magnetically conductive connecting webs 26, radially in the region of the through-opening 8, as a result of which, in the circumferential direction, in particular every second pole segment 4 or every second pole segment region 5, 5′, 5″ are connected to one another. Owing to the same magnetic potential, there is substantially no magnetic flux between the magnetically equally polarized pole segments 4 or pole segment regions 5, 5′, 5″ connected in such a way, for which reason there are substantially no magnetic leakage fluxes therebetween. FIG. 11a) shows a perspective illustration merely of the pole pieces 4 and/or pole segment regions 5, 5′, 5″ of part of the rotor 2.

The further ones which are provided in the circumferential direction and have opposite magnetic potential in comparison with the pole pieces 4 and/or pole segment regions 5, 5′, 5″ just described are connected by means of connecting webs 27. The respective connecting webs 26 and 27 of the oppositely polarized pole segments 4 in this case have an axial spacing of 4 mm, for example, as a result of which leakage fluxes are advantageously limited or avoided. Pole segment regions 5, 5′, 5″ of a pole segment plane, arranged perpendicular to the rotor axis 1′, of the rotor 2 are illustrated in FIG. 11b), wherein it can be seen in particular that only every second pole segment 4 or every second pole segment region 5, 5′, 5″ is connected by means of the connecting webs 26 and 27, respectively. The pole segment regions 5, 5′, 5″ of each separate pole segment 4 are mechanically connected in the axial direction in a manner known per se, for example by means of stamping and stacking, adhesive bonding or else welding or screwing.

The permanent magnets 3 are arranged in the circumferential direction between the pole segments 4, as already described for the further exemplary embodiments. The rotor 2 can be configured, in accordance with the invention, in such a way that the permanent magnets 3 extend towards the rotor axis 1′ partially or completely in the form of a wedge, which means that the planes of the permanent magnets 2, which planes are arranged in the circumferential direction of the rotor 2, approach one another towards the rotor axis. Owing to the wedge shape, in particular the space requirement required by the connecting webs 26, 27 is found.

Owing to the pole segment regions 5, 5′, 5″ of a pole segment plane of the rotor 2 which are arranged in particular in the axial end regions of the rotor 2 and are highlighted in FIG. 11a) and whose connecting webs 27 directly adjoin the connecting webs 26 of magnetically oppositely polarized pole segment regions 5, 5′, 5″, the mechanical stability of the rotor 2 can be improved, wherein the leakage fluxes in this region are nevertheless increased. Furthermore, the mechanical stability of the rotor 2, corresponding to the exemplary embodiment in FIG. 10, is preferably increased by an encapsulation by plastic infection molding (not illustrated), which substantially encloses the rotor. An improvement in the torque transfer onto the rotor shaft 22 in the sense of FIG. 10 can be achieved, for example, by a correspondingly arranged knurl, which is likewise enclosed by the encapsulation by plastic injection molding, on parts of the circumference of the rotor shaft, wherein a puncture can also be provided for axially securing the torque transfer disc 7 so as to improve the torque transfer to the shaft 22, in particular in connection with form elements 23. Advantageously, in accordance with this embodiment, it is possible in particular to limit the number of individual parts for the manufacture of the electric motor 1 or rotor 2.

While the above description constitutes the preferred embodiment of the present invention, it will be appreciated that the invention is susceptible to modification, variation and change without departing from the proper scope and fair meaning of the accompanying claims.

1. A rotor for a permanent magnet electric machine, in in the form of a brushless DC machine, which rotor is arranged concentrically around a rotor axis and has a through-opening extending along the rotor axis for receiving a shaft, comprising, permanent magnets and pole segments extending along the rotor axis, wherein the permanent magnets and the pole segments are arranged alternately in a circumferential direction around the rotor axis, in that a cross-sectional area of at least one of the pole segments is formed in at least one first pole segment region so as to be asymmetrical with at least one first shaped portion arranged in a radially outer region with respect to the rotor axis of the pole segment, wherein the first shaped portion extends substantially in the circumferential direction.

2. The rotor as claimed in claim 1, in that at least one of the pole segments comprises at least one second pole segment region, in which at least one second shaped portion, which forms asymmetrically a cross-sectional area, is provided in the radially outer region in a substantially opposite circumferential direction with respect to the first shaped portion in the first pole segment region.

3. The rotor as claimed in claim 2, wherein least one of the pole segments comprises at least one third pole segment region, wherein the third pole segment region is substantially symmetrical and without the first or the second shaped portion.

4. The rotor as claimed in claim 3, further comprising in that the proportion of the first pole segment regions is approximately 20% to approximately 30%, the proportion of the second pole segment regions is approximately 20% to approximately 30%, and the proportion of the third pole segment regions is approximately 40% to approximately 60% of a total of all the pole segment of the rotor.

5. The rotor as claimed in claim 1, further comprising in that at least one of the pole segments consists of a substantially magnetically conductive material.

6. The rotor as claimed in claim 1, further comprising in that a maximum spacing between the first shaped portion and the rotor axis is less than or equal to an outer radius of the rotor.

7. The rotor as claimed in claim 1, further comprising in that at least one torque transfer disc is provided on at least one end face of the rotor, which the at least one torque transfer disc has disc opening extending in the direction of the rotor axis for receiving and mechanically connecting to the shaft.

8. The rotor as claimed in claim 7, further comprising in that at least one means for fixing the torque transfer disc is provided on the pole segments, wherein in particular at least one pole segment opening or cutout is provided in at least one of the pole segments, into which at least one rod-shaped element is inserted, which rod-shaped element is mechanically connected to the torque transfer disc.

9. The rotor as claimed in claim 7, further comprising in that at least one of the first shaped portions is formed in the region of the torque transfer disc in a radially outer region with respect to the rotor axis of the torque transfer disc, wherein the first shaped portion extends substantially in the circumferential direction.

10. The rotor as claimed in claim 7, further comprising in that the torque transfer disc consists of a substantially magnetically nonconductive material.

11. The rotor as claimed in claim 1, further comprising in that the shaft has at least one form element for receiving recesses surrounded by the pole segments or the first pole segment regions.

12. The rotor as claimed in claim 1, further comprising in that magnetically conductive connecting webs are provided, which connect only pole segments of different pole segments.

13. The use of the rotor as claimed in claim 1 in a motor vehicle brake system or a motor vehicle steering system.

14. The rotor as claimed in claim 1 further comprising in that the at least one pole segment consists of a substantially ferromagnetic or ferrimagnetic material.)

15. The rotor as claimed in claim 1 further comprising in that a first and a second torque transfer disc is provided on opposite end faces of the rotor, in which at least the first transfer disc has a first opening extending in the direction of the rotor axis for receiving and mechanically connecting the shaft, wherein a second opening in the second torque transfer disc for receiving the shaft has a smaller diameter than the first opening.)

16. The rotor as claimed in claim 1 further comprising in that magnetically conductive connecting webs are provided, which connect only magnetically identically polarized of the first, or the second, or the third pole segment regions of different of the pole segments.

17. The rotor as claimed in claim 3 further comprising wherein a plurality of the pole segments having the first pole segment region are stacked together on the rotor, and a plurality of the pole segments having the second pole segment region are stacked together on the rotor, and a plurality of the pole segments having the third pole segment region are stacked together on the rotor.
